(19) United States
(12) Patent Application Publication
(10) Pub. No.: US 2022/0105685 A1
(43) Pub. Date: Apr. 7, 2022

(54) Object Locations in Additive Manufacturing

(71) Applicant: Hewlett-Packard Development Company, L.P., Spring, TX (US)

(72) Inventors: Sergio Gonzalez Martin, Sant Cugat del Valles (ES); Leticia Rubio Castillo, Sant Cugat del Valles (ES); Manuel Freire Garcia, Sant Cugat del Valles (ES)

(73) Assignee: Hewlett-Packard Development Company, L.P., Spring, TX (US)

(21) Appl. No.: 17/417,783

(22) PCT Filed: Jun. 28, 2019
(86) PCT No.: PCT/US2019/039834

§ 371 Date: Jun. 24, 2021

(51) Int. Cl. B29C 64/386; B33Y 50/00; B22F 10/80; G05B 19/4099

(52) U.S. Cl. CPC B29C 64/386; B33Y 50/00; G05B 2219/49023; G05B 19/4099; B22F 10/80

(57) ABSTRACT

In an example, a method includes receiving, by at least one processor, object model data describing a first object to be generated in additive manufacturing and an intended object generation location of the first object, wherein the intended object generation location is a relative location within a generic fabrication chamber. The method may further comprise determining, by at least one processor, a location for generation of the first object in a first fabrication chamber, wherein the first fabrication chamber is an intended fabrication chamber of object generation. The location may be an absolute location in the first fabrication chamber which corresponds to the relative location within the generic fabrication chamber.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example method of determining a location for object generation;

FIGS. 2A and 2B show examples for defining relative locations in generic fabrication chambers;

FIG. 3 is a flowchart of an example method of generating at least one object;

FIGS. 4 and 5 are simplified schematic drawings of example apparatus for additive manufacturing; and

FIG. 6 is a simplified schematic drawing of an example machine-readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber (also referred to as a build volume herein). According to one example, a suitable build material may be PA12 build material commercially referred to as V1R10A “HP PA12” available from HP Inc.

In some examples, selective solidification is achieved using heat in a thermal fusing additive manufacturing operation. This may comprise directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be derived from structural design data). The fusing agent may have a composition which absorbs energy such that, when energy (for example, heat) is applied to the layer, the build material heats up, coalesces and solidifies upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. In one example such a fusing agent may comprise any or any combination of an infra-red light absorber, a near infra-red light absorber, a visible light absorber and a UV light absorber. Examples of print agents comprising visible light absorption enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed to reduce or prevent coalescence by, for example, cooling the build material or through some other mechanism. According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer designing a three-dimensional model of an object to be generated, for example using a computer aided design (CAD) application. The model may define the solid portions of the object. To generate a three-dimensional object from the model using an additive manufacturing system, the model data can be processed to derive slices or parallel planes of the model. Each slice may define a portion of a respective layer of build material that is to be solidified or caused to coalesce by the additive manufacturing system.

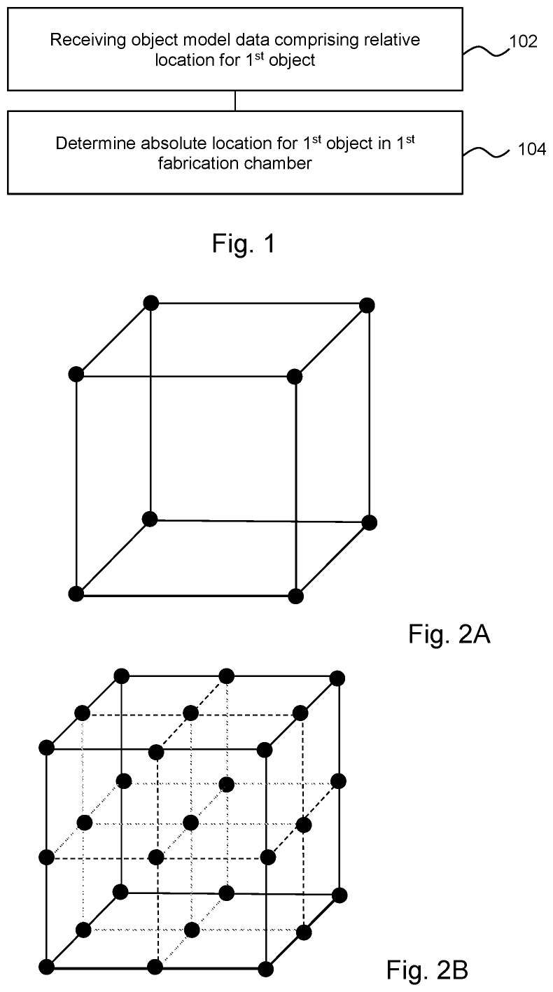

FIG. 1 is an example of a method, which may comprise a computer implemented method of determining a location for generation of an object in additive manufacturing.

The method comprises, in block 102, receiving, by at least one processor, object model data describing a first object to be generated in additive manufacturing and an intended object generation location of the object, wherein the intended object generation location is a relative location within a generic fabrication chamber. In some examples, the object model data may include the relative location.

The object model data may represent the shape or form of an object, for example as a polygonal mesh (e.g. a STereoLithographic (STL) data file, or 3MF file) characterising the form of an object. In other examples, the object may be descried using a plurality of sub-volumes referred to herein as ‘voxels’ (i.e. three-dimensional pixels). In some such examples, each voxel represents a region of the object which is individually addressable in object generation. Voxels may provide a representation of the object which may be used to determine where to place print agents. For example, an amount of print agent (or no print agent) may be associated with each of the voxels. In some examples, an object may be represented as a stack of 2D slices, wherein each slice may represent a layer of the object as 2D polygons. In other examples, the object model data may comprise instructions and/or parameters for generating virtual object, as described in greater detail below.

The data may for example be received over a communications network, or from a local memory or the like.

The relative location within the generic fabrication chamber may describe the location of the object in a coordinate system which includes at least one generalised characteristic of a fabrication chamber. For example, a location may be the centre of the generic fabrication chamber, the bottom of the fabrication chamber, or a relative coordinate such as

$$\frac{1}{n}$$

of the maximum x dimension,

$$\frac{1}{m}$$

of the maximum y dimension and

$$\frac{1}{p}$$

of the maximum z dimension (where x and y are the axes of the object generation plane and z is the height in object generation). In other words, in some examples, the relative location within the generic fabrication chamber may describe the location of the object in a coordinate system which includes at least one identifiable ‘anchor’ point and, in some examples, an offset which is defined relative to dimensions of a generic fabrication chamber. In some examples, the relative location may be defined in terms of an accessible volume of a fabrication chamber, as further discussed below.

Block 104 comprises determining, by at least one processor (which may be the same or different processor(s) to those referred to in block 102), a location for generation of the first object in a first fabrication chamber (the first fabrication chamber being the intended fabrication chamber of object generation), by determining an absolute location in the first fabrication chamber corresponding to the relative location within the generic fabrication chamber. The determined absolute location may for example be an intended location of an identifiable point on the object, for example an object vertex, a tagged location, the centre of mass of the object, or the like. In other examples, the absolute location may be specified as a plurality of coordinates, which specify the location of a plurality of points on the objects (e.g. object vertices), or in some other way.

For example, this may comprise determining absolute coordinates which correspond to the relative location. For example, a location of ‘centre’ may result in the evaluation of the midpoint between 0 and the maximum values of each x, y and z axes, and setting the resulting x, y and z values as the coordinates of object generation.

The method of FIG. 1 therefore allows a generalised location to be translated into an absolute coordinate for a particular fabrication chamber.

As mentioned above, in some examples, the entirety of the volume of the fabrication chamber is not available for receiving objects and, instead, an accessible (or printable) volume of a fabrication chamber may be defined. Either or both of the relative and the absolute location may be defined in terms of such accessible volumes in some examples. In such examples, the method may comprise determining the accessible volume, for example based on at least one of: the fabrication chamber dimensions; at least one material to be used in additive manufacturing; an object generation mode; an object generation apparatus type, for reasons such as those set out in greater detail below.

For example, certain areas of a fabrication chamber may be known to result in a relatively high rate of fabrication errors and such areas could be excluded from use by defining a smaller accessible volume. In other examples, increasing the distance from a fabrication chamber wall may result in an object with better dimensional tolerance characteristics (perhaps because the object fabrication temperature may be more stable) and therefore a smaller accessible volume may be defined to improve dimensional accuracy.

In some examples, the virtual volume in which objects are placed may be defined to be smaller than the actual volume. This may allow the virtual volume—and the virtual objects—to be scaled prior to determination of additive manufacturing instructions. Such scaling may allow for compensation for subsequent shrinkage. Once the object or objects are formed, or during their formation, as an object cools and the build material solidifies forming the final object or objects, the printed objects can undergo shrinkage. This shrinkage may be dependent on the type of build material, cooling rate and/or print agent used. This shrinkage means that a final printed object may not represent the object as described by the object model data received by the printer.

Therefore, in some examples, a compensation or scaling is applied to object model data in order to compensate for the shrinking of objects, for example after or during printing. In other words, in some examples the objects are printed larger than the size defined in the object model data, for example having been scaled by a predetermined factor such that, after shrinkage, they are the size specified in the original object model data.

To allow for this, when a user is placing a virtual (unscaled) object in a virtual fabrication chamber, this may be confined to a volume which, when scaled, is still within the usable build volume of the fabrication chamber. Thus, a virtual volume may define a volume within a fabrication chamber in which an (unscaled) virtual object can be placed.

The shrinkage may be associated with a particular choice of build material. For example, PA12 mentioned above is associated with a 2.5-3% shrinkage; object models (and therefore a virtual version of the build volume) may be enlarged to compensate for such shrinkage. However, another material (e.g. PA11), may be associated with a different shrinkage. In some examples, different accessible volumes may therefore be defined for the same fabrication chamber, depending on the intended build material to be used in a particular object generation operation. Of course, further build materials may be used.

The whole ‘virtual’ fabrication chamber may then be scaled to fill the ‘real’ fabrication chamber (unless any zones thereof are excluded for other reasons, for example as mentioned above).

In some examples, the first object may be a calibration object, which may be used for characterising at least one parameter of additive manufacturing. For example, prior to generating objects, apparatus may undergo calibration and/or checking of the apparatus (where calibration in the context may comprise finding the measured temperature which corresponds to the melting temperature of the build material, given any or any combination of variability in temperature sensors, build material types and batches, apparatus condition, environmental conditions and the like).

In examples of such calibration/checking exercises, a small portion of a few successive layers of build material towards the bottom of a fabrication chamber may be caused to fuse by the addition of fusing agent. A ‘blank’ layer (i.e. without fusing agent) of build material may be formed on top of this fused patch and heat applied until the blank layer melts above the fused patch. By leaving a layer of the build material blank, melting occurs relatively slowly, allowing a change in gradient of temperature associated with melting to be readily identified. The exercise may serve to calibrate the heat control set points and as a warning of a fault in the apparatus (for example, if temperature does not increase as anticipated, a heat lamp may not be operating correctly), and the rest of a build operation may be abandoned if a fault is detected.

In one example, such a calibration object may for example comprise a disc or column of solidified material, which may be a few centimetres (e.g. 2 to 10 cm) in diameter, and may be intended to be formed in the first few layers of an accessible volume.

Therefore, according to the method of FIG. 1, the object model data may describe a first object as such a disc, with an intended object generation location of the centre of the base of an accessible volume of a generic fabrication chamber. The absolute location may have coordinates identifying the centre of the base of the accessible volume of the first fabrication chamber when the first fabrication chamber is intended to generate the calibration object.

Other examples of calibration objects comprise objects which may be generated to characterise deformations in object generation. Such objects may in some examples have expected dimensions, and, following generation thereof, the actual dimensions may be measured and compared to the expected dimensions. This information may be used to inform dimensional compensation(s) to apply to object models prior to object generation. The object(s) may in some examples be selected or designed so as to provide easily characterisable dimensions, for example comprising protrusions or faces between which measurements can be acquired. In addition, an intended object generation location may be specified such that the space within the fabrication chamber is adequately sampled. In one example, calibration objects may be distributed throughout the fabrication chamber. In some examples, objects may occupy the same locations in a number of additive manufacturing operation (or ‘build operations’) to characterise any changes occurring in the fabrication process over time. In another example, different objects may be generated in different locations over different build operations. Other such objects may be generated to characterise (and in some examples calibrate) other additive manufacturing parameters, for example relating to object properties such as tensile strength, coloration, and the like. In other examples, the object may comprise a component for the additive manufacturing apparatus itself.

Therefore, according to the method of FIG. 1, the object model data may describe the first object as comprising a calibration object for characterising at least one parameter of the additive manufacturing process, and an intended location of generation, wherein the location may be selected in order that system parameters of additive manufacturing (e.g. temperatures or other apparatus parameters, object properties, deformation behaviour and the like) can be appropriately characterised. For example, in one build operation, eight instances of a calibration object may be specified in object model data, each object associated with a relative location defined with a predetermined spacing from a specified corner of the accessible volume of a fabrication chamber, for example in terms of x, y and z offsets from the respective corner. In some examples, the spacing may be specified in absolute units, while in other examples, the units may be relative to a dimension of the accessible volume.

In some examples, objects to be generated may be specified without reference to the fabrication chamber in which they are to be provided. To consider the example of the calibration disc described above, if no location is specified, there is a risk that the object will be placed in a location which is not suitable (for example, not suitable for it to perform its function as a calibration object) or which is outside the accessible volume. However, such objects may generally be usefully generated over a range of apparatus and materials, providing predetermined ‘standards’ against which an additive manufacturing system may be evaluated, and therefore models of such objects may be predetermined as ‘system models’.

To determine the location of object generation, such system models could be provided with a suitable absolute specification of location for any conceivable fabrication chamber/defined accessible fabrication chamber (which may vary with, for example, build material as described above), or a user may manually ‘place’ a virtual version of the object once a fabrication chamber and parameters such as build material choices are known. However, both of these methods are cumbersome. By specifying a relative location in a generic fabrication chamber, and translating this relative location to an absolute location, placement of such objects is simplified.

FIGS. 2A and 2B show examples to illustrate how relative locations may be designated for a generic fabrication chamber based on ‘anchor points’, which may be predefined anchor points, such that they can be used to determine absolute locations in a first fabrication chamber.

FIG. 2A shows examples of anchor points which are defined in a generic fabrication chamber. In general, locations within the generic fabrication chamber may serve as anchor points. Such anchor points may comprise locations which will be common to all fabrication chambers. For example, and as shown in FIG. 2A, it may be assumed that all fabrication chambers have eight corners, four of these corners having a Z component of zero and four of the corners having a z coordinate of Zₘₐₓ (i.e. the maximum value on the Z axis), wherein the x and y coordinates are either 0, Xₘₐₓ, or Y_{Max}. Thus, the anchor points may be the corners (shown as black ‘nodes’ in FIG. 2A). From such coordinates, a relatively defined point along each of the axes may be determined. For example, Z_{mid} may be the coordinate which is halfway between Z=0 and Zₘₐₓ, and correspondingly the centre of the fabrication chamber may be defined as (X_{mid}, Y_{mid}, Z_{mid}). In other examples, an offset may be specified. In some examples, the offset may also be relative (e.g. relative to Xₘₐₓ, Y_{Max} or Zₘₐₓ) although in other examples the offset may be an absolute spacing in one or more axes, for example in microns, millimetres, centimetres, etc. In further examples, an intermediate location may be interpolated by providing a weighted combination of anchor points.

The specification of the anchor points may be predetermined for a given system, or may be specified in data provided with (or in) object model data.

In another example, as is shown in FIG. 2B, a predetermined grid may be specified, which provides a grid coordinate system. For example, the volume of the fabrication chamber may be divided such that each axis is divided into N divisions, where N is any number (for example, an integer), and where N may be different for different axes. In the example of FIG. 2B, each axis is divided into three. Thus, there are 27 defined locations (or anchor points) shown as black ‘nodes’. In a practical example, N may for example be between 5 and 20, for example being around 10, and may be the same for each axis. This may provide sufficient resolution without overcomplicating the system. Thus, in this coordinate system, the centre of the volume may be specified as [1, 1, 1] in the grid coordinate system (assuming an origin of [0,0,0], counting nodes in each of x, y and z, if the bottom left corner is taken as the origin. The comments made in relation to offsets and interpolation in respect of FIG. 2A also apply here. In the example of FIG. 2B, there are nine defined boxes. In another example of a relative location, the relative location may for example be defined as being within a grid box (e.g. the object may be centred within the grid box).

The defined grid may then be scaled to the actual dimensions of the intended fabrication chamber of use (or the accessible volume thereof, which may be determined with reference to intended parameters of the object generation operation such as build material choices, print mode and the like), and the absolute location of an identified location relative to the grid, once scaled, may be determined.

Such relative locations allow the specification of object locations in a robust way. As mentioned above, this allows a single object location definition and/or object definition to be used for multiple materials, printing profiles, and/or fabrication chamber sizes.

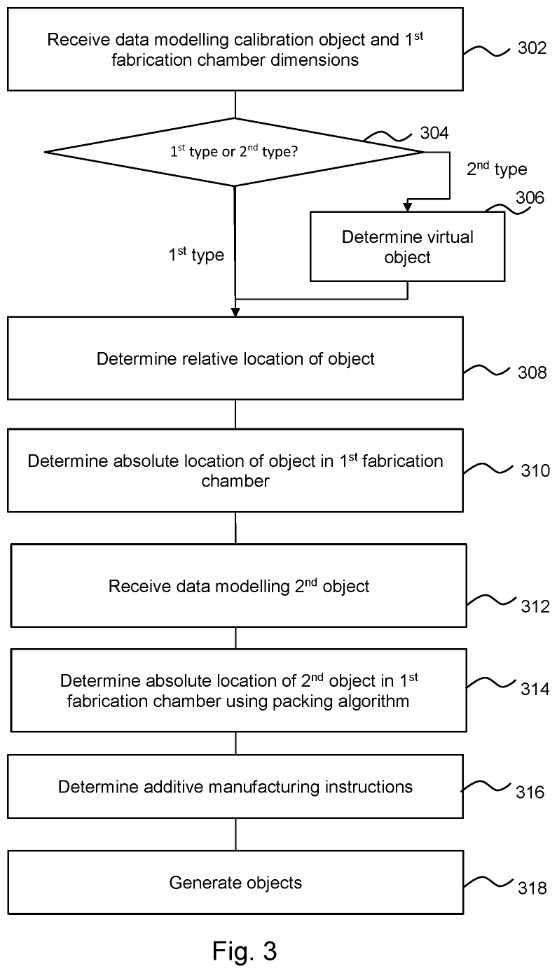

FIG. 3 shows an example of a method for generating an object.

Block 302 comprises receiving, at a processor, (i) data modelling an object to be generated, which in this example is a calibration object, which includes a relative location in a generic fabrication chamber and (ii) a specification of the dimensions of the accessible volume of a first fabrication chamber, wherein the first fabrication chamber is the intended fabrication chamber for object generation. The object model data and the specification of the dimensions of the accessible volume of the first fabrication chamber may be provided from different sources and/or received separately.

In block 304, an object description type is determined by at least one processor. Specifically, it is determined whether the object model data is of a first type describing a virtual object or of a second type comprising instructions for determining a virtual object.

For example, while object models of the first type may comprise polygon meshes, stacks of object slices, voxel models or the like, object models of the second type may comprise algorithms or formulations for determining the shape of an object having particular characteristics. In some examples, object models of the second type may be specified to have dimensions which are defined relative to the dimensions of a generic fabrication chamber. For example, an X dimension of the object model may be specified as being

$$\frac{Xmax}{M} ,$$

where M is any number, or as extending between identified (i.e. predefined) anchor points (or other points defined relative to anchor points). In other examples, the dimensions may be described in predetermined units, for example as microns, millimetres, centimetres or the like.

These two object model types may be considered to be fully specified models (first type) or procedurally derived models (second type). Such procedurally derived models may be specified using parameters, and may have a relatively simple geometry, e.g. cubes, spheres or particular elongate shapes suited for generating objects which may be tested for tensile strength and the like.

Specifying an object as a procedurally derived object model may allow for further adaption to the size and/or configuration of the actual fabrication chamber, or the accessible volume thereof.

If the object model is the second type, then the method proceeds to block 306, and a virtual object model is determined, in some examples using the specification of the dimensions of the accessible volume of the first fabrication chamber. To consider an example of a cube, block 306 may comprise converting a relative dimension (say, 1/10^{th} of the x dimension of the generic fabrication chamber) into a length in units such as millimetres using the actual length of the x dimension of the first fabrication chamber.

Block 308 comprises determining, using at least one processor, the relative location of the object. This may comprise determining, from the object model data, a specification of an anchor point and in some examples may comprise determining an offset therefrom.

Block 310 comprises determining, using at least one processor, an absolute location in a first fabrication chamber using the relative location and the specification of the dimensions of the accessible volume of the first fabrication chamber. For example, this may comprise resolving the relative dimensions to provide x, y and z values within the accessible volume of the first fabrication chamber.

Block 312 comprises receiving, at at least one processor, object model data describing a second object, which is to be generated in the same object generation operation as the first object (i.e. the first and second object are to share space in the same additive manufacturing fabrication chamber). This may be received from the same source or a different source to the object model data describing the first object (and may be receive with, or before, that data). In this example, no location data is specified in the object model data describing the second object. Instead, the location of object generation for the second object is determined in block 314 using a packing algorithm. The packing algorithm may for example place objects so as to respect a minimum spacing, and in some examples may seek to minimise a height of a build volume and/or maximise a number of objects. In some examples, this may comprise deriving a plurality of possible arrangements and scoring the arrangements against criteria such as the overall height, the number of objects, or the like. In other examples, the location may be user specified, or may be specified as the solution to an optimisation problem, or determined in some other way.

Block 318 comprises determining, using at least one processor, additive manufacturing instructions for generating the first and second objects.

For example, determining additive manufacturing instructions (which may also be referred to herein as, or may comprise, object generation instructions and/or print instructions) may comprise determining ‘slices’ of a virtual build volume containing the first and second objects, and rasterizing these slices into pixels (or voxels, i.e. three-dimensional pixels). An amount of print agent (or no print agent) may be associated with each of the pixels/voxels. For example, if a pixel relates to a region of a build volume which is intended to solidify, the additive manufacturing instructions may be derived to specify that fusing agent should be applied to a corresponding region of build material in object generation. If however a pixel relates to a region of the build volume which is intended to remain unsolidified, then additive manufacturing instructions may be determined to specify that no agent, or a coalescence modifying agent such as a detailing agent, may be applied thereto. In addition, the amounts of such agents may be specified in the derived instructions and these amounts may be determined based on, for example, thermal considerations and the like. The location of the first object may be considered to be fixed in such an operation such that other objects may be packed ‘around’ the first object (and any other objects which treated in the same way as the first object).

Block 318 comprises generating the first and second object (in some examples, along with other objects) using the additive manufacturing instructions. Generating the object may comprise generating the object based on the additive manufacturing instructions (or ‘print instructions’). For example, the object may be generated layer by layer. For example, this may comprise forming a layer of build material, applying print agents, for example through use of ‘inkjet’ liquid distribution technologies in locations specified in the additive manufacturing instructions for an object model slice corresponding to that layer using at least one print agent applicator, and applying energy, for example heat, to the layer. Some techniques allow for accurate placement of print agent on a build material, for example by using print heads operated according to inkjet principles of two dimensional printing to apply print agents, which in some examples may be controlled to apply print agents with a resolution of around 600 dots per inch (dpi), or 1200 dpi. A further layer of build material may then be formed and the process repeated, for example with the additive manufacturing instructions for the next slice. In other examples, objects may be generated using directed energy, or through use of chemical binding or curing, or in some other way.

In some examples blocks 316 and 318 may be carried out concurrently. In particular, one slice of object model data may be processed to determine additive manufacturing instructions for generating a corresponding layer in an additive manufacturing operation while a previous layer is being generated. This reduces the need to store processed additive manufacturing instructions (which can be large, and thus consume significant processing resources). In addition, the time-consuming processing stage may be combined with the object generation processing time, which is efficient. However, in some additive manufacturing operations, a consistent layer processing time is indicated as this results in a more consistent outcome (for example, less warping than may be seen if some layers may be allowed to cool for longer than others). Therefore, the processing of the data may be such that the time to process the data of a slice is at least not substantially longer than the time to generate a layer.

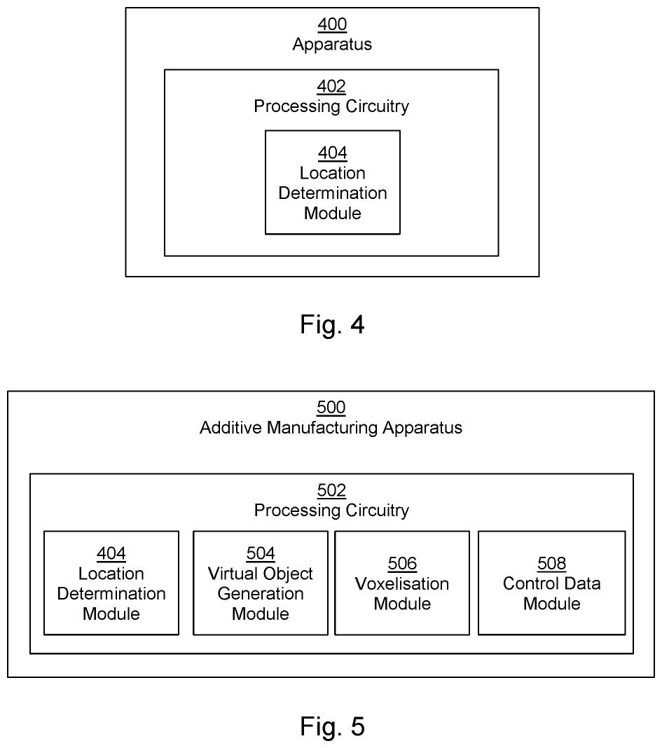

FIG. 4 shows an example of an apparatus 400 comprising processing circuitry 402, the processing circuitry 402 comprising a location determination module 404.

In use of the apparatus 400, the location determination module 404 determines, for a first fabrication chamber, a location for object generation corresponding to a relative fabrication chamber location provided with (or in) object model data, wherein the relative fabrication chamber location is specified for a generic fabrication chamber. As also discussed above, this may for example allow a single specification of an object (which may have a particular purpose such as characterising an additive manufacturing system for calibration or the like) to be provided, which may be generated in a suitable location in each of a plurality of different apparatus, or with different object generation parameters. This in turn simplifies specification of such objects and the generation location thereof, which may for example be specified as ‘standards’, ‘system objects’ or calibration objects for use in a plurality of circumstances without being individually tailored to those circumstances.

FIG. 5 shows an example of an additive manufacturing apparatus 500 comprising processing circuitry 502, wherein the processing circuitry 502 comprises the location determination module 404 described in relation to FIG. 4. In addition, the additive manufacturing apparatus 500 further comprises a virtual object generation module 504, a voxelisation module 506, and a control data module 508.

In use of the additive manufacturing apparatus 500, the virtual object generation module 504 generates (or derives) virtual objects from object model data which comprises instructions for generating the virtual object. Such instructions may allow the determination of ‘procedurally derived objects’ as discussed above. For example, the instructions may comprise an algorithm or rule for determining the object shape, for example the object may be specified as a geometrical form such as a sphere, cube, cuboid or the like having a certain dimensions. In some examples, the object may be defined using relative dimensions, wherein the dimension(s) are specified relative to the dimension(s) of a generic fabrication chamber (or the accessible sub volume thereof) as is described above.

In use of the additive manufacturing apparatus 500, the voxelisation module 506 represents the object model data as a plurality of predetermined discrete volumes, for example using rasterization techniques.

In use of the additive manufacturing apparatus 500, the control data module 508 determines additive manufacturing apparatus control data to generate object(s) from object model data. This may for example deriving additive manufacturing instructions or print instructions as described above. As discussed in greater detail above in relation to additive manufacturing instructions, the control data in some examples specifies an amount of print agent to be applied to each of a plurality of locations on a layer of build material, and may be generated based on object model data.

In use, the additive manufacturing apparatus 500 may generate at least one object using the additive manufacturing apparatus control data.

For example, the additive manufacturing apparatus 500, in use thereof, may generate the object in a plurality of layers (which may correspond to respective slices of at least one object model) according to the control data. The additive manufacturing apparatus 500 may for example generate an object in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. In other examples, heat may be selectively applied, and/or chemical agents such as curing or binding agents may be applied. The additive manufacturing apparatus 500 may comprise additional components not shown herein, for example any or any combination of a fabrication chamber, a print bed, printhead(s) for distributing print agents, a build material distribution system for providing layers of build material, energy sources such as heat lamps and the like.

The processing circuitry 402, 502 or the modules thereof may carry out any of the blocks of FIG. 1 and/or any of blocks 302 to 316 of FIG. 3.

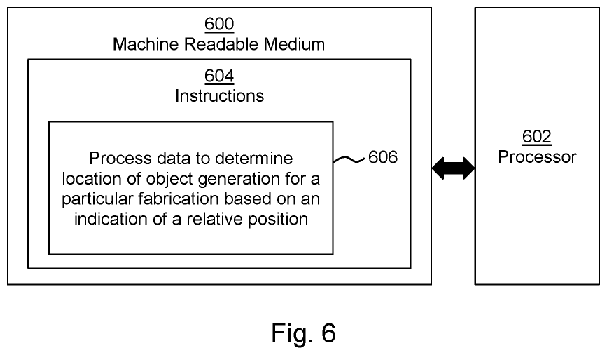

FIG. 6 shows a tangible machine-readable medium 600 associated with a processor 602. The machine-readable medium 600 comprises instructions 604 which, when executed by the processor 602, cause the processor 602 to carry out tasks. In this example, the instructions 604 comprise instructions 606 to cause the processor 602 to process data representing a first object to determine a location of object generation for a particular fabrication chamber based on an indication of a relative position within a printable zone of a generic fabrication chamber. The printable zone may correspond to the accessible object generation volume described above. In some examples, the relative position is relative to an anchor point within the printable zone, wherein the anchor point may be a predefined anchor point. The printable zone may comprise any of the features of the accessible volume described above. The relative position may have any of the features discussed in relation to the relative location.

In some examples, the instructions when executed cause the processor 602 to carry out any of the blocks of FIG. 1 and/or any of blocks 302 to 316 of FIG. 3. In some examples, the instructions may cause the processor 602 to act as any part of the processing circuitry 402, 502 of FIG. 4 or FIG. 5.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that block(s) in the flow charts and/or block diagrams, as well as combinations of the blocks in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus functional modules of the apparatus (such as the location determination module 404, the virtual object generation module 504, the voxelisation module 506, and/or the control data module 508) may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Machine-readable instructions may also be loaded onto a computer or other programmable data processing device(s), so that the computer or other programmable data processing device(s) perform a series of operations to produce computer-implemented processing, thus the instructions executed on the computer or other programmable devices may realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims. Based on means based at least in part on.

The features of any dependent claim may be combined with the features of any of the independent claims or other dependent claims.

1. A method comprising:
receiving, by at least one processor, object model data describing a first object to be generated in additive manufacturing and an intended object generation location of the first object, wherein the intended object generation location is a relative location within a generic fabrication chamber; and
determining, by at least one processor, a location for generation of the first object in a first fabrication chamber, wherein the first fabrication chamber is an intended fabrication chamber of object generation, by determining an absolute location in the first fabrication chamber corresponding to the relative location within the generic fabrication chamber.

2. A method according to claim 1 further comprising determining, by at least one processor, additive manufacturing instructions for generating the first object at the determined absolute location.

3. A method according to claim 2 further comprising generating the first object using the additive manufacturing instructions.

4. A method according to claim 1 wherein the relative location is specified using a grid coordinate system, and determining the absolute location comprises scaling the grid to an accessible volume of the first fabrication chamber.

5. A method according to claim 1 wherein the relative location is specified using a predefined anchor point in an accessible volume of the first fabrication chamber.

6. A method according to claim 1 wherein the object model data further comprises an indication of an object description type, the object description type comprising (i) a virtual object or (ii) instructions for determining a virtual object and wherein, if the object model data comprises instructions for determining a virtual object, the method comprises determining, by at least one processor, a virtual object according to the instructions.

7. A method according to claim 1 wherein the first object is to be included in an object generation operation which is further to generate a second object, wherein the location of the second object is determined using a packing algorithm.

8. A method according to claim 1 wherein the first object is a calibration object for use in characterising at least one parameter of additive manufacturing.

9. Apparatus comprising:
a location determination module to determine, for a first fabrication chamber, a location for object generation corresponding to a relative fabrication chamber location provided with object model data, wherein the relative fabrication chamber location is specified for a generic fabrication chamber.

10. Apparatus according to claim 9 further comprising a virtual object generation module to generate a virtual object from object model data comprising instructions for generating the virtual object.

11. Apparatus according to claim 9 further comprising a voxelisation module to represent object model data as a plurality of predetermined discrete volumes.

12. Apparatus according to claim 9 further comprising a control data module to determine additive manufacturing apparatus control data to generate an object from the object model data.

13. Apparatus according to claim 12 further comprising additive manufacturing apparatus to generate at least one object using the additive manufacturing apparatus control data.

14. Tangible machine-readable media storing instructions which, when executed by a processor cause the processor to:
process data representing a first object to determine a location of object generation for a printable zone of a particular fabrication chamber based on an indication of a relative position within a printable zone of a generic fabrication chamber.

15. Tangible machine-readable media storing instructions according to claim 14 wherein the relative position is specified relative to an anchor point within the printable zone of the generic fabrication chamber.
